(19) United States
(12) Patent Application Publication
(10) Pub. No.: US 2003/0088597 A1
(43) Pub. Date: May 8, 2003

(54) Method and system for string representation of floating point numbers

(75) Inventor: Douglas A. Wood, Indianapolis, IN (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/920,523

(22) Filed: Aug. 2, 2001

(51) Int. Cl. G06F 7/00

(52) U.S. Cl. 708/204

(57) ABSTRACT

An information handling system comprising computer hardware and/or computer software for implementing a method for generating and mapping a string representation of a floating point number having a mantissa and an exponent is disclosed. The method involves the establishment of a pair of numeric strings and a decimal string. One of the numeric strings is indicative of a numerical sign of the mantissa and a numerical sign of the exponent. The other numeric string is indicative a numerical value of the exponent. The decimal string is indicative of a numerical value of the mantissa. The numeric strings and the decimal strings are arrayed to generate the string representation. A predefined attribute is utilized to map the string representation to a directory.

### BACKGROUND OF THE INVENTION

1. Field of the Invention

The present invention generally relates to a representation of real numbers in character based transmission and storage formats used by computer systems and networks. Examples of such media include, but are not limited to, directories, relational databases, and XML documents. The present invention specifically relates to a generation of a string representation of the floating point number that allows them to be correctly collated using the standard ASCII collating sequence.

2. Description of the Related Art

A computer directory, such as those accessed by the LDAP protocol, store data as strings of characters encoded in ASCII or in one of its derivatives (e.g., Unicode or UCS8). This representation facilitates the exchange of data between directories and other applications utilizing a variety of hardware and operating systems. Currently real numbers are represented in some variant of scientific notation. The collating sequence for the scientific notation form of string representations of real numbers, which are treated as arbitrary strings, is different from the collating sequence for the values represented by the string representations. For example, the value 5020.0 can be represented in scientific notation as 5.02e3 and the value 21000.0 can be represented as 2.10e4. Arranging these numbers in ascending order based on value provides the following ordering:

1. 5.02e3

2. 2.10e4

However, when the scientific notation representations are sorted as character strings without regard to their content the following ordering is obtained:

1. 2.10e4

2. 5.02e3

Because the collating sequence for the real number value is not the same as the collating sequence for the string representation of the value, directories that wish to support sorting and comparison of real numbers must be made aware that a given data element represents a real number and provide specific support for its comparison. Consequently, the method for sorting and comparison of real numbers is more elaborate than it should be. The present invention addresses this problem by defining a string representation for real numbers that has the same collating sequence as the values represented.

### SUMMARY OF THE INVENTION

The present invention relates to a method and system for string representation of floating point numbers that overcomes the shortcomings associated with the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for generating and mapping a string representation of a floating point number having a mantissa and an exponent. One or more characters are established within a first numeric string that is indicative of a numerical sign of the mantissa and a numerical sign of the exponent. One or more characters are established within a second numeric string that is indicative of a numerical value of the exponent. And, one or more characters are established within a decimal string that is indicative of a numerical value of the mantissa.

A second form of the present invention is an information handling system for generating and mapping a string representation of a floating point number having a mantissa and an exponent. The information handling system comprises the following means. A means for establishing one or more characters within a first numeric string that is indicative of a numerical sign of the mantissa and a numerical sign of the exponent. A means for establishing one or more characters within a second numeric string that is indicative of a numerical value of the exponent. And, a means for establishing one or more characters within a decimal string that is indicative of a numerical value of the mantissa.

A third form of the present invention is computer program product in a computer readable medium for generating and mapping a string representation of a floating point number having a mantissa and an exponent. The computer program product comprises the following computer readable code. Computer readable code for establishing one or more characters within a first numeric string that is indicative of a numerical sign of the exponent. Computer readable code for establishing one or more characters within a second numeric string that is indicative of the numerical sign and a numerical value of the exponent. And, computer readable code for establishing one or more characters within a decimal string that is indicative of a numerical value of the mantissa.

The foregoing forms and other forms, features and advantages of the present invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of one embodiment in accordance with the present invention of an information handling system;

FIG. 2 is a block diagram of one embodiment in accordance with the present invention of computer hardware employed in the FIG. 1 information handling system;

FIG. 3 is a block diagram of one embodiment in accordance with the present invention of computer software employed in the FIG. 1 information handling system; and

FIG. 4 is a flow chart of one embodiment in accordance with the present invention of a string representation routine implemented by the FIG. 3 computer software.

### DETAILED DESCRIPTION OF THE PRESENTLY PREFERRED EMBODIMENTS

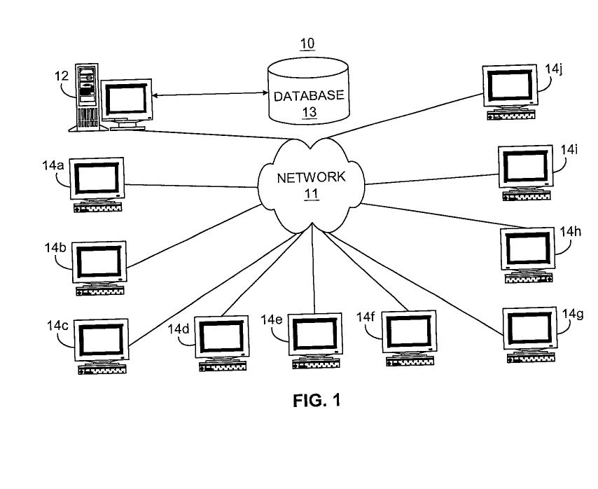

Referring to FIG. 1, an information handling system 10 is shown. System 10 comprises a network 11 such as, for example, an intranet, an Internet, a wide area network, or a local area network. System 10 further comprises a server computer 12, and a plurality of client computers 14a-14j. Network 11 provides communication links between server computer 12, and client computers 14a-14j. Accordingly, network 11 may include permanent connections, such as wire or fiber optic cables, or temporary connections, such as telephone or wireless communications, among server computer 12, and client computers 14a-14j. Other embodiments of system 10 may include additional networks 11, server computers 12, and client computers 14.

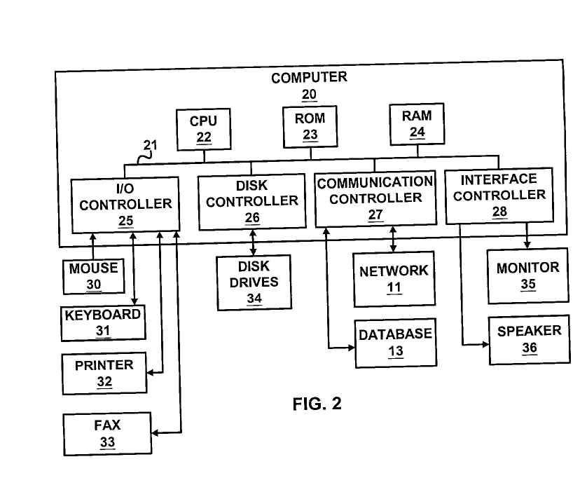

Server computer 12 and client computers 14a-14j may be configured in any form for accepting structured inputs, processing the inputs in accordance with prescribed rules, and outputting the processing results as would occur to those having ordinary skill in the art, such as, for example, a personal computer, a workstation, a super computer, a mainframe computer, a minicomputer, a super minicomputer, and a microcomputer. Referring to FIG. 2, one computer hardware embodiment of server computer 12 is shown.

The computer hardware includes a computer 20 having a bus 21 for facilitating electrical communication among a central processing unit (CPU) 22, a read-only memory (ROM) 23, a random access memory (RAM) 24, an input/output (I/O) controller 25, a disk controller 26, a communication controller 27, and a user interface controller 28. CPU 22 is preferably one of the Intel families of microprocessors, one of the Motorola families of microprocessors, or one of the various versions of a Reduced Instruction Set Computer microprocessor such as the PowerPC chip manufactured by IBM. ROM 23 stores a conventional operating system, such as an AIX operating system or IBM's OS/2 operating system. ROM 23 also stores various controlling programs such as the Basic Input-Output System (BIOS) developed by IBM. RAM 24 is the memory for loading the operating system and selectively loading the controlling programs.

Controller 25 is an aggregate of controllers for facilitating an interaction between CPU 22 and pointing devices such as a mouse 30 and a keyboard 31, and between CPU 22 and output devices such as a printer 32 and a fax 33. Controller 26 is an aggregate of controllers for facilitating an interaction between CPU 22 and data storage devices such as disks drives 34 in the form of a hard drive, a floppy drive, a local drive, and a compact-disc drive. Controller 27 is an aggregate of controllers for facilitating an interaction between CPU 22 and network 11, and between CPU 22 and database 13. Controller 28 is an aggregate of controllers for facilitating an interaction between CPU 22 and a graphic display device such as a monitor 35, and between CPU 22 and an audio device such as a speaker 36.

The computer hardware shown in FIG. 2 is also representative of a computer hardware embodiment of client computers 14a-14j with the exception of a communication between CPU 22 and database 13.

Those having skill in the art will appreciate alternative computer hardware embodiments of server computer 12 and client computers 14a-14j for implementing the principles of the present invention.

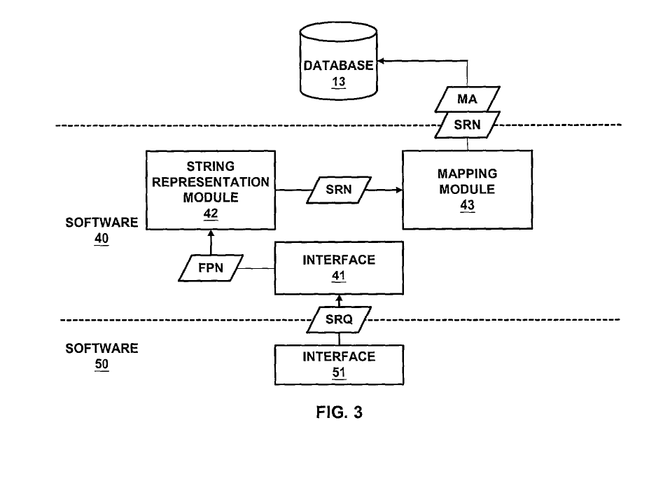

Referring additionally to FIG. 3, server computer 12 includes software 40 and each client computer 14a-14i includes software 50. Software 40 is a computer program product physically stored within ROM 22 and/or a disk storage device that is uploaded to RAM 23 whereby ROM 22 and/or RAM 22 are computer readable mediums that are electrically, magnetically or chemically altered to store computer readable code. In other embodiments of server computer 12, software 40 can be fully or partially implemented with digital circuitry, analog circuitry, or both, such as for example, in the form of a floating point processor.

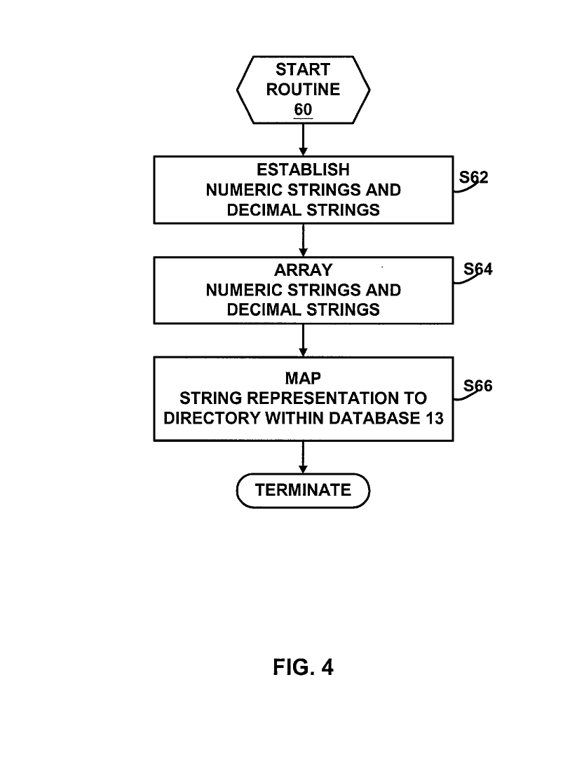

Software 40 includes an interface 41, a string representation module 42, and a mapping module 43 for implementing a string representation routine 60 as shown in FIG. 4. Software 50 includes an interface 51 for providing a storage request SRQ of a floating point number FPN embedded within the storage request SRQ.

Referring additionally to FIG. 4, in response to a reception of storage request SRQ from interface 52, interface 41 extracts floating point number FPN from therein and transmits floating point number FPN to string representation module 41. In response to a reception of floating point number FPN, string representation module 41 commences an implementation of routine 60. During a stage S62 of routine 60, string representation module 41 establishes (i.e., computes or retrieves from memory) a collating numeric string, an exponent numeric string, and a mantissa decimal string. The collating numeric string includes one or more characters that are indicative of a numerical sign of a mantissa of floating point number FPN and a numerical sign of an exponent of floating point number FPN. The following TABLE 1 illustrates one embodiment of numerical values of a collating numeric string having one character:

TABLE 1

| COLLATING | | |
|---|---|---|
| NUMERIC | MANTISSA | EXPONENT |
| STRING | SIGN | SIGN |
| 1 | Negative | Positive |
| 2 | Negative | Negative |
| 3 | Neutral | Neutral |
| 4 | Positive | Negative |
| 5 | Positive | Positive |

As shown in TABLE 1, the numerical value of 3 for the collating numeric string is repsentative of floating point number FPN equating zero (0).

The exponent numeric string includes one or more characters indicative of a numerical value of the exponent of floating point number FPN. The following TABLE 2 illustrates one embodiment of a computation of an exponent numeric string having three (3) characters as correlated to the collating numeric string when floating point number FPN has sixty-four (64) bits:

TABLE 2

| COLLATING | EXPONENT |
|---|---|
| NUMERIC | NUMERIC |
| STRING | STRING |
| 1 | 999 - Exponent Numerical Value |
| 2 | Exponent Numerical Value |
| 3 | 000 |
| 4 | Exponent Numerical Value + 999 |
| 5 | Exponent Numerical Value |

The exponent numeric string is right justified and zero padded to the left as needed as will be exemplary illustrated in connection with a subsequent description of a TABLE 5 herein.

The mantissa decimal string includes one or more characters indicative of a numerical value of the mantissa of floating point number FPN. The following TABLE 3 illustrates one embodiment of computation of the mantissa decimal string having seventeen (17) characters as correlated to the collating numeric string when floating point number FPN has sixty-four (64) bits:

TABLE 3

| COLLATING | MANTISSA |
|---|---|
| NUMERIC | DECIMAL |
| STRING | STRING |
| 1 | Mantissa Numerical Value + 10 |
| 2 | Mantissa Numerical Value + 10 |
| 3 | 0.0000000000000000 |
| 4 | Mantissa Numerical Value |
| 5 | Mantissa Numerical Value |

The mantissa decimal string has only one character to the left of the decimal point and zero padded to the right as needed as will be exemplary illustrated in connection with a subsequent description of a TABLE 5 herein.

During a stage S64 of routine 60, string representation module 42 generates string representation SRN by arraying the collating numeric string (CNS), the exponent numeric string (ENS), and the mantissa decimal string (MDS). The following TABLE 4 illustrates one embodiment of string representation SRN when floating point number FPN has sixty-four (64) bits:

TABLE 4

| CNS | ENS | MDS |
|---|---|---|
| n | n n n | n . n n n n n n n n n n n n n n n n |

As shown in TABLE 4, a blank character is inserted between the collating numeric string and the exponent numeric string, and a blank character is inserted between the exponent numeric string and the mantissa decimal string to facilitate the human readability of string representation SRN. The following TABLE 5 illustrates exemplary generations of a string representation SRN from a floating number point FPN:

TABLE 5

| COLLATIN | FLOATING POINT | STRING |
|---|---|---|
| G | NUMBER | REPRESENTATION |
| SEQUENCE | FPN | SRN |
| 1 | 3.25e5 | 5 005 3.2500000000000000 |
| 2 | 8.40e-5 | 4 994 8.4000000000000000 |
| 3 | 8.40e-7 | 4 992 8.4000000000000000 |
| 4 | 7.23e-7 | 4 992 7.2300000000000000 |
| 5 | 0.00e0 | 3 000 0.0000000000000000 |
| 6 | −4.25e4 | 2 004 5.7500000000000000 |
| 7 | −6.35e4 | 2 004 3.6500000000000000 |
| 8 | −6.35e3 | 2 003 3.6500000000000000 |
| 9 | −4.00e-104 | 1 895 6.0000000000000000 |
| 10 | −4.00e-105 | 1 894 6.0000000000000000 |
| 11 | −6.00e-105 | 1 894 4.0000000000000000 |

Those having ordinary skill in the art will appreciate that each generation of a string representation SRN for a floating point number FPN as listed in TABLE 5 maintains the same collating sequence as the values of the floating point number FPN.

During a stage S66 of routine 60, mapping module 43 utilizes a mapping attribute MA to map string representation SRN to a directory (e.g., a directory based on a Lightweight Directory Access Protocol) within database 13. Routine 60 is terminated upon completion of stage S66.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for generating and mapping a string representation of a floating point number having a mantissa and an exponent, said method comprising:
establishing at least one character within a first numeric string that is indicative of a numerical sign of the mantissa and a numerical sign of the exponent;
establishing at least one character within a second numeric string that is indicative of a numerical value of the exponent; and
establishing at least one character within a decimal string that is indicative of a numerical value of the mantissa.

2. The method of claim 1, further comprising:
arraying the first numeric string, the second numeric string, and the decimal string to thereby generate the string representation of the floating point number.

3. The method of claim 2, further comprising:
inserting a first blank character between the first numeric string and the second numeric string; and
inserting a second blank character between the second numeric string and the decimal string.

4. The method of claim 1, further comprising:
utilizing a floating point attribute corresponding to the floating point number to thereby map the string representation to a directory.

5. An information handling system for generating and mapping a string representation of a floating point number having a mantissa and an exponent, said information handling system comprising:
means for establishing at least one character within a first numeric string that is indicative of a numerical sign of the mantissa and a numerical sign of the exponent;
means for establishing at least one character within a second numeric string that is indicative of a numerical value of the exponent; and
means for establishing at least one character within a decimal string that is indicative of a numerical value of the mantissa.

6. The information handling system of claim 5, further comprising:
means for arraying the first numeric string, the second numeric string, and the decimal string to thereby generate the string representation of the floating point number.

7. The information handling system of claim 6, further comprising:
means for inserting a first blank character between the first numeric string and the second numeric string; and
means for inserting a second blank character between the second numeric string and the decimal string.

8. The information handling system of claim 5, further comprising:
means for utilizing a floating point attribute corresponding to the floating point number to thereby map the string representation to a directory.

9. A computer program product in a computer readable medium for generating and mapping a string representation of a floating point number having a mantissa and an exponent, said computer program product comprising:
computer readable code for establishing at least one character within a first numeric string that is indicative of a numerical sign of the mantissa and a numerical sign of the exponent;
computer readable code for establishing at least one character within a second numeric string that is indicative of a numerical value of the exponent; and
computer readable code for establishing at least one character within a decimal string that is indicative of a numerical value of the mantissa.

10. The computer program product of claim 9, further comprising:
computer readable code for arraying the first numeric string, the second numeric string, and the decimal string to thereby generate the string representation of the floating point number.

11. The computer program product of claim 10, further comprising:
computer readable code for inserting a first blank character between the first numeric string and the second numeric string; and
computer readable code for inserting a second blank character between the second numeric string and the decimal string.

12. The computer program product of claim 9, further comprising:
computer readable code for utilizing a floating point attribute corresponding to the floating point number to thereby map the string representation to a directory.
